(19) United States
(12) Patent Application Publication
(10) Pub. No.: US 2020/0049196 A1
(43) Pub. Date: Feb. 13, 2020

(54) Bearing For Reciprocating Conveyor Slats

(71) Applicant: Keith Manufacturing Co., Madras, OR (US)

(72) Inventors: Daniel Jackson, Madras, OR (US); John Cook, Madras, OR (US)

(73) Assignee: Keith Manufacturing Co., Madras, OR (US)

(21) Appl. No.: 16/282,032

(22) Filed: Feb. 21, 2019

Related U.S. Application Data
(60) Provisional application No. 62/633,399, filed on Feb. 21, 2018.

(51) Int. Cl. F16C 29/02; B65G 25/06

(52) U.S. Cl. CPC F16C 29/02; B65G 25/065

(57) ABSTRACT

Reciprocating floor slat conveyor systems typically utilize floor slats that reciprocate back and forth while riding on bearings. The bearings sometimes have a curved “J” shape and, as a consequence, are commonly referred to as “J bearings.” The design disclosed here is an improved version of a J bearing that has segmented surfaces that are angled, rather than curved, relative to each other. Angled surfaces reduces voids between bearings and floor slats.

### TECHNICAL FIELD

This disclosure relates to reciprocating floor slat conveyors. More particularly, this disclosure relates to bearings that support the reciprocating floor slats that are used in conveyor systems of this kind.

### BACKGROUND

Reciprocating floor slat conveyor systems are well known. Some of these systems have reciprocating slats that are supported on each side by stationary slats. The stationary slats have “wings” that extend laterally outwardly. The lateral wings are covered by curved bearing strips that have a “J” cross-section. The curve of the “J” overlaps the end of each wing. The J-shaped bearing and wing of the stationary slat are received within a lower side region of the reciprocating slat, such side region being defined by an upper, side, and lower wall that cooperatively present a bearing-receiving recess (“side recess”) underneath each lateral side of the reciprocating slat.

The following discloses an improvement to the shape and dimensions of J bearings from the earlier conventional design.

### SUMMARY

The bearing disclosed here has an elongated top surface (looking in cross-section) relative to prior designs. Rather than have a continuously curved “J” shape that covers the end of each lateral wing on a stationary slat, the present design has segmented interior surfaces (in contact with the outer surface of each wing) that are “angled” relative to each other. This enables the outer end surface of the bearing to have less outside curvature within the walls of the slat's side recess. By creating less curvature, the bearing more efficiently fills the void space within the side recess of the reciprocating slate (i.e., a void between the outer surfaces of the bearing and the inner surfaces of the side recess on the slat). The void space has the potential to create an accumulation area for particulate matter from the load carried by the conveyor system—which can sometimes work its way between reciprocating slats and bearings as the slats reciprocate back-and-forth. The present disclosure is an improvement on that problem but, at the same time, the bearing shape still provides a small space between the end of the bearing (inside the side recess) to enable particulate matter, if any, to escape and drop out from the reciprocating floor slat system.

One edge of the bearing terminates underneath a lateral side wing. The other edge of the bearing (or “inner edge”) terminates near a central top surface region of the stationary slat. For reasons relating to saving weight, the stationary slat can be made of extruded aluminum. However, the central top surface just described may be covered by or carry a narrow strip of thin steel that serves as both a resting surface for the edges of reciprocating slats (one on each side) and a gap filler. With respect to the latter, the strip reduces problems attributable to voids under the edges of the reciprocating slats that can capture and accumulate particulate matter from the load carried by the conveyor system. The inner edge of the bearing is angled laterally, upwardly and inwardly, from bottom to top, so that it partly overlaps a side edge of the steel strip just described, thus holding it in place.

The foregoing will become better understood upon consideration of the following more detailed description that is to be taken in conjunction with the drawings that are part of the present disclosure.

### BRIEF DESCRIPTION OF THE DRAWINGS

In the drawings, like reference numerals and letters refer to like parts throughout the various views, and wherein:

FIG. 1 is a cross-sectional view taken through an arrangement of two side-by-side reciprocating floor slats that are supported by stationary slats;

FIG. 2 is a cross-sectional view similar to FIG. 1 that shows an arrangement of reciprocating floor slats supported by stationary slats extending from one sidewall to another, the sidewalls being representative of the walls of a trailer or similar container in which a typical reciprocating floor slat conveyor system might be installed;

FIG. 3 is an enlarged cross-sectional view of the region where a stationary slat supports the edges of reciprocating slats, one on each side;

FIG. 4 is a cross-sectional view of a stationary slat with side wings and shows the improved bearings disclosed here, one on each respective lateral side wing;

FIG. 5 is a cross-sectional view of a stationary slat with side wings;

FIG. 6 is a view similar to FIG. 4, but shows a different stationary slat design;

FIG. 7 is a view similar to FIG. 5, but shows a different stationary slat design;

FIG. 8 is a view of the stationary slat shown in FIG. 7, but with bearings on the side wings;

FIG. 9 is a cross-sectional view of a stationary slat configuration adjacent to one sidewall of a container or the like;

FIG. 10 is a cross-sectional view of just the stationary slat shown in FIG. 9; and

FIG. 11 is a cross-sectional view of a stationary slat configuration at adjacent to another side of a container or the like.

### DETAILED DESCRIPTION

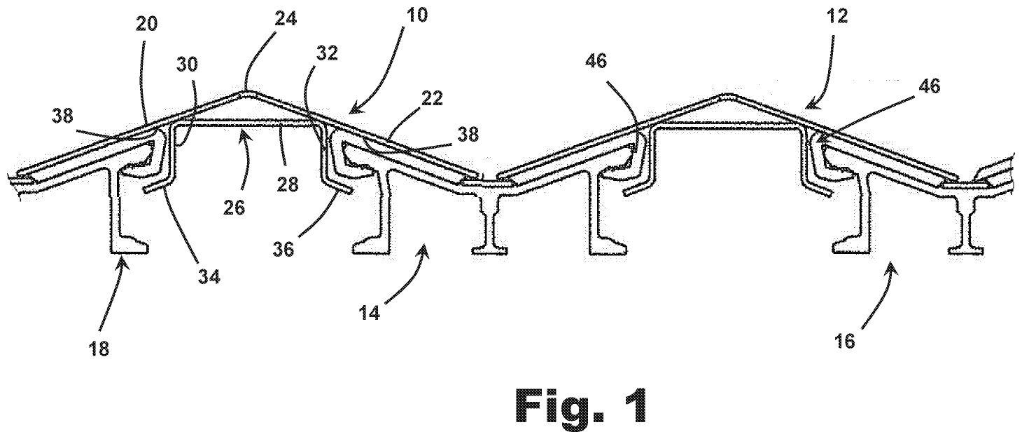

Referring now to the drawings, and first to FIG. 1, shown generally at 10 and 12 are two reciprocating floor slats supported by a stationary slat. The stationary slat is generally indicated by numeral 14. As a person skilled in the art would recognize, the reciprocating slats 10, 12 also have stationary slats that support the other sides of the reciprocating slats that are not fully shown in the drawings. These other stationary slats are generally indicated at 16 and 18, respectively.

Referring to the left-hand reciprocating slat 10, this slat is an all-steel slat that has an inverted “V” shape consisting of two lateral top surfaces 20, 22 that come together at a peak 24. An underlying support piece (indicated generally at 26) is connected to the inverted “V” just described. The support 26 includes a horizontal section 28, opposite lateral side sections 30, 32 that depend downwardly, and outwardly flared sections 34, 36.

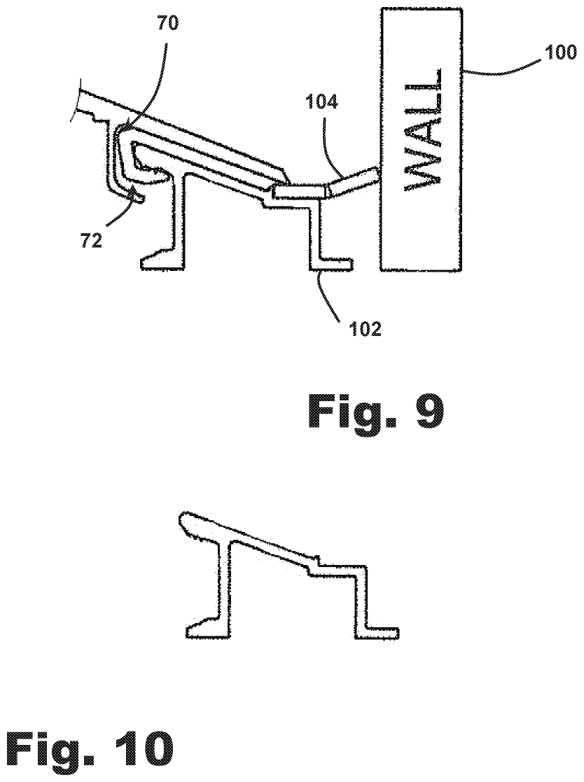

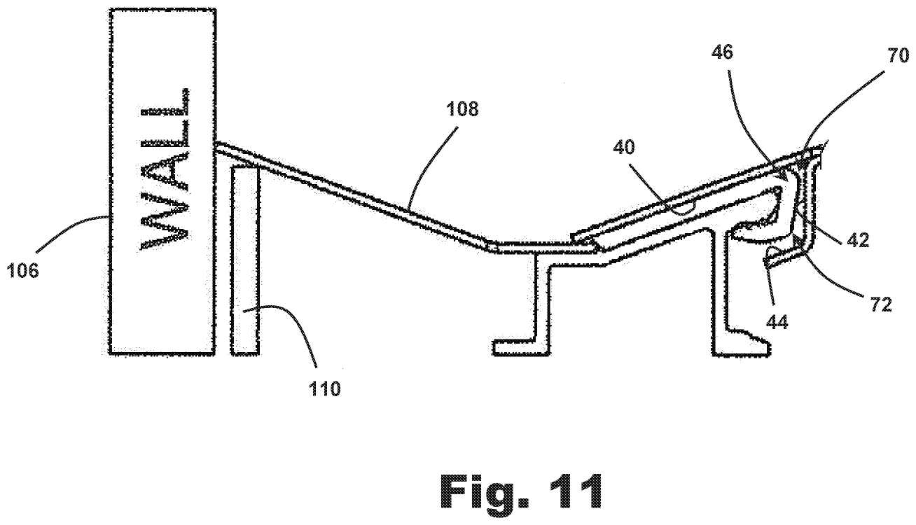

An underside area 38 of the top lateral surface parts 20, 22 that make up the inverted “V” of the reciprocating slat 10, along with the side sections and flared sections just described, cooperatively form a lateral side recess (one on each side) of each reciprocating slat 10, 12. This is better illustrated by reference numerals 40, 42, 44 in FIG. 11 (and also FIG. 9). The side recess is generally indicated by arrow 46 in those illustrations.

Attention is now directed to FIG. 4, which shows just a stationary slat, indicated generally at 48, alone and apart from the reciprocating slats 10, 12 just described. The stationary slat 48 has side wings 50, 52, one on each lateral side. Each side wing 50, 52 is covered by a bearing indicated, respectively, by arrows 54, 56. Each bearing 54, 56 has an upper surface 58 upon which one side of a reciprocating slat rides, back-and-forth. An underside surface 60 of the bearing rests upon a corresponding upper wing surface 62. The underside surface 60 angles upwardly, from inside to outside where it makes a sharp bend downwardly, as shown by arrow 64. The angle between surfaces 60, 64 is a relatively sharp acute angle. The bearing 54 then bends sharply inwardly, as shown at 66, with the angle between items 64 and 66 being close to 90°.

The above bearing configuration creates an outer curve, at the location generally indicated by arrow 68. The radius of the curve 68 is shorter than the radius of smooth-curved “J” bearings used in the past. This enables the “point” of the bearing 54 to project farther into the corner of the reciprocating slat's side recess 46, thereby leaving a smaller void between the bearing and sidewalls of the recess.

The reduced size of the void is indicated by arrow 70 in FIGS. 9 and 11. Even though the size of the void 70 is reduced, a gap still remains between the bearing and the walls of the side recess (the location of the gap is indicated by arrow 72 in FIGS. 9 and 11).

As discussed above, the reduced size of the void 70 also reduces the amount of material that can accumulate in that area. To the extent any material does accumulate, the gap 72 allows the material to work its way downwardly through the system, to eventually fall on the ground.

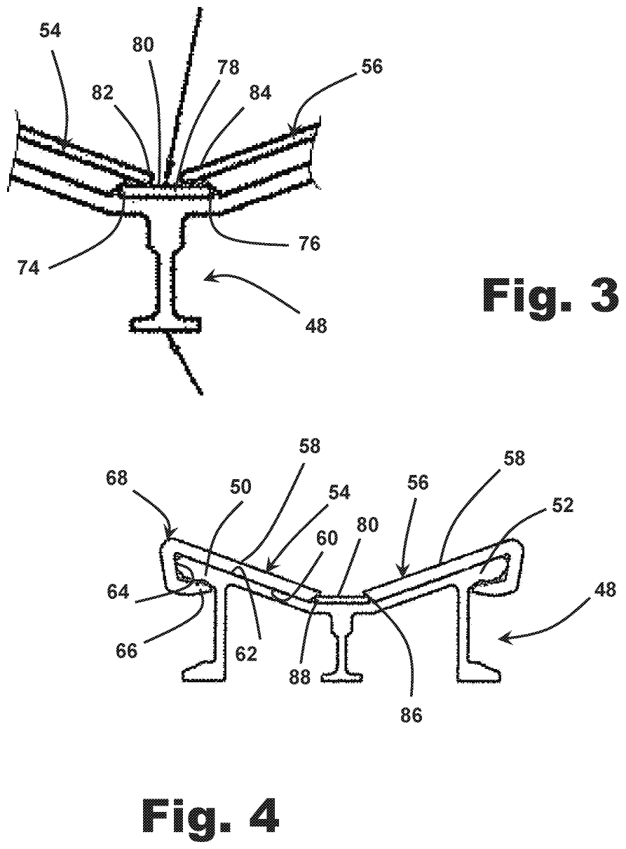

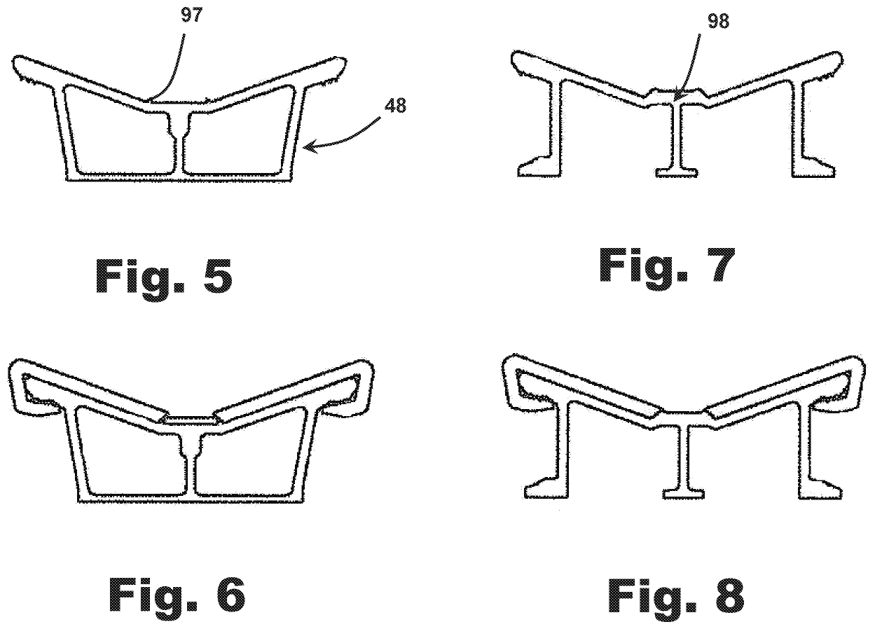

Referring now to FIG. 3, the bearings 54, 56 terminate with angled inner edges 74, 76. These edges 74, 76 angle (from bottom to top) upwardly toward the center of the fixed slat 48. The fixed slat 48 has a top surface 78 upon which rests a thin steel plate 80. The edges, 82, 84 of the reciprocating slats 10, 12 rests directly on the top surface of the steel plate 80. The angled edges 74, 76 of the bearings 54, 56 overlap and capture the opposite lateral edges 86, 88 of the steel strip 80 underneath the edges of the reciprocating slats. Having the width of the bearings 54, 56 extend the distance from the steel plate to the point where they bend around the wings 50, 52 of the stationary slat creates a longer distance of continuous, sliding contact, relative to past designs. This longer distance makes it more difficult for particulate matter to work its way up along the underside of the reciprocating slats to the void areas 70 described above.

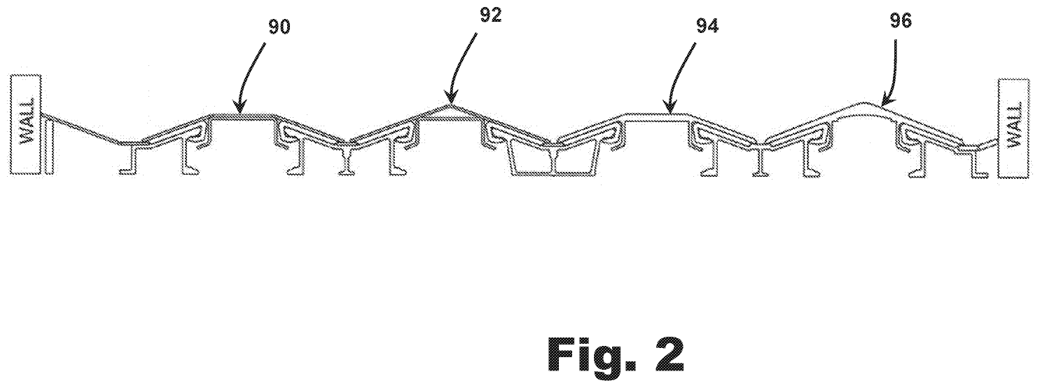

FIG. 2 shows a series of different reciprocating floor slat profiles 90, 92, 94, 96 that are representative of the type of reciprocating slats that might be used in conjunction with the bearings described herein. Reference 97 shows the location of beads on the upper surface of the stationary slat 48 that serves to help capture the steel strip 80.

FIGS. 7 and 8 show modified stationary slats that lack the steel strip 80 described above. Instead, the central region of the stationary slat (shown at arrow 98) is thickened in lieu of using a steel strip.

FIGS. 9 and 10 illustrate the above configuration as it would be used near a sidewall 100. In this configuration, the stationary slat 48 is “halved” with an outer foot 102 that stabilizes the slat near the wall 100. The steel strip 80 previously described is extended, as shown at 104, to provide a seal with the wall 100. FIG. 11 is similar, except that it shows an opposite sidewall 106 with an even greater extension or extended version 108 of the steel strip. In this case, the steel strip 108 is supported at 110. Obviously, these dimensions are a variable that is dependent on the overall width of the system.

The foregoing description is not to be taken in a limiting sense. The scope of patent protection is limited not by the foregoing description but by the patent claim or claims that are allowed by the U.S. Patent Office, the interpretation of which are to be made in accordance with the standard doctrines of patent claim interpretation.

What is claimed is:

1. An improved “J” bearing for use in connection with a reciprocating floor slat conveyor, the bearing improvement comprising:
a first surface of the bearing that angles upwardly; and
a second surface of the bearing that is connected to said first surface, and with said second surface being angled downwardly, and wherein the angle between said first and second surfaces is an acute angle.
